(19) United States
(12) Patent Application Publication
(10) Pub. No.: US 2026/0081852 A1
(43) Pub. Date: Mar. 19, 2026

(54) DATA SECURITY SYSTEM ASSET AND USER IDENTITY MANAGEMENT

(71) Applicant: Lucidum Inc., Cincinnati, OH (US)

(72) Inventors: Joel M. Fulton, Cincinnati, OH (US); Jeremy Sherwood, Beaverton, OR (US); Shuning Wu, Mountain View, CA (US)

(21) Appl. No.: 18/889,648

(22) Filed: Sep. 19, 2024

(51) Int. Cl. H04L 9/40

(52) U.S. Cl. CPC H04L 43/065; H04L 43/04; H04L 63/1425

(57) ABSTRACT

Methods, systems, and devices for data security system computing asset and user identity management are described. For example, the data security system may obtain input records from multiple event information sources. The data security system may manage multiple assets for a client that may be associated with multiple user accounts. The multiple event information sources may provide computing asset identifiers (IDs) and/or user IDs in different formats. The data security system may determine linkages between different computing asset IDs between different user IDs in event records. For example, the data security system may use machine learning models to identify linkages between different computing asset IDs, between different user IDs in event logs, and/or between data records obtained from multiple event information sources. Accordingly, the data security system may provide a holistic view of events associated with the same computing asset and/or the same user account.

### FIELD OF TECHNOLOGY

The present disclosure relates generally to database systems and data processing, and more specifically to data security system asset and user identity management.

### BACKGROUND

A data security system may be employed to detect and manage data security risks associated with one or more computing assets. The data monitored by the data security system may be generated, stored, or otherwise used by the one or more computing assets, examples of which may include mobile phones, tablet computers, personal computers, servers, databases, virtual machines, cloud computing systems, file systems (e.g., network-attached storage (NAS) systems), or other data storage or processing systems. For example, a data security system may monitor for malware and/or suspicious activity within the one or more computing assets. In some examples, a data security system may receive indications of known types of malware from one or more malware information sources. The data security system may monitor the one or more computing assets for the known types of malware.

### BRIEF DESCRIPTION OF THE DRAWINGS

FIG. 1 illustrates an example of a computing environment that supports data security system asset and user identity management in accordance with aspects of the present disclosure.

FIG. 2 shows an example of an identity management diagram that supports data security system asset and user identity management in accordance with aspects of the present disclosure.

FIG. 3 shows an example of a user identity management diagram that supports data security system asset and user identity management in accordance with aspects of the present disclosure.

FIG. 4 shows an example of a computing asset identity management diagram that supports data security system asset and user identity management in accordance with aspects of the present disclosure.

FIG. 5 shows an example of a data classification diagram that supports data security system asset and user identity management in accordance with aspects of the present disclosure.

FIG. 6 shows an example of a process flow that supports data security system asset and user identity management in accordance with aspects of the present disclosure.

FIG. 7 shows a block diagram of a data security system controller that supports data security system asset and user identity management in accordance with aspects of the present disclosure.

FIG. 8 shows a diagram of a system including a device that supports data security system asset and user identity management in accordance with aspects of the present disclosure.

FIG. 9 shows a flowchart illustrating methods that support data security system asset and user identity management in accordance with aspects of the present disclosure.

### DETAILED DESCRIPTION

A data security system may be employed to monitor for and manage data security risks associated with one or more computing or assets. For example, the one or more computing assets may be associated with an entity which may be a customer or subscriber of the data security system. For example, an entity may be an individual or an organization. A computing asset may be any device, physical or virtual, capable of processing, storing, transmitting, and/or receiving data. For example, a computing asset may be a stationary device (e.g., a desktop computer or access point) or a mobile device (e.g., a laptop computer, a tablet computer, or a smart phone). As another example, a computing asset may be a commercial computing device, such as a server or collection of servers. In some examples, a computing asset may be a virtual device (e.g., a virtual machine). In some examples, the data security system may scan (e.g., periodically or on-demand) or may otherwise monitor for security risks based on computing objects (e.g., files, software applications, or any other programming elements) stored at or accessible to the computing assets. For example, the data security system may store a listing of known malware, and the data security system may monitor for the known malware within the computing assets monitored by the data security system. As another example, a data security system may monitor for suspicious activity on or associated with one or more computing assets. For example, the data security system may track which user accounts access and/or otherwise use computing assets, and the data security system may track unauthorized access to computing assets or computing resources.

In some cases, the data security system may be responsible for hundreds or thousands of physical and virtual computing assets across multiple networks that may collectively generate thousands or millions of data records. For example, data records may include incident reports for the detection of suspicious activity or malware. As another example, a data record may include the addition of a computing asset to an organization or a network. As another example, a data record may include information such as records of scans of computing assets (e.g., which may or may not reveal suspicious activity). As another example, a data record may involve an action performed by the data security system, such as blocking the download of a virus or removal of a virus or malware from a computing asset. The data security system may store data records for monitored organizations (e.g., data records generated in association with monitoring computing assets) in a database.

In some examples, the data security system may receive input records such as event logs or data records from multiple sources. For example, a malware protection program may generate input records (e.g., event logs), for example based on scans of computing assets, and an access control system may generate input records based on users accessing computing assets. An input record may refer to a record (e.g., an event log or data record) obtained by the data security system. An input record may include a computing asset identifier associated with a computing asset for which the input record was generated. As another example, different types of computing assets may user different malware protection programs (e.g., a first malware protection program may manage computing assets that use a first operating system and a second malware protection may manage computing assets that use a second operating system). The different event information sources and/or the different computing assets may use different identifiers (IDs) to refer to the same computing asset and/or to the same user account.

In accordance with aspects of this disclosure, the data security system may determine linkages between different computing asset IDs and/or between different user IDs in input records. For example, the data security system may determine if two different computing asset IDs in different input records correspond to the same computing asset (e.g., the same computing asset monitored by the data security system). For example, the data security system may use machine learning models or techniques to determine whether different computing asset IDs correspond to the same computing asset. For example, a first computing asset ID may be a serial number, and a second computing asset ID may be a medium access control (MAC) address or an internet protocol (IP) address, and the data security system may correlate the two computing asset IDs as belonging to the same computing asset. The data security system may indicate, in a database that stores event records for the input records, a true or common ID for the computing asset based on identifying the two computing asset IDs as belonging to the same computing asset. As another example, the data security system may determine if two different user IDs in different input records correspond to the same user account (e.g., the user account of a client or customer of the data security system). For example, the data security system may use machine learning techniques or models to determine whether different user IDs correspond to the same user account. For example, a first user ID may be a first and last name, and a second user ID may be an email address, and the data security system may correlate the two user IDs as belonging to the same user account. The data security system may indicate, in a database that stores data records for the input records, a true or common ID for the user account based on identifying the two user IDs as belonging to the same user account. Accordingly, the data security system may provide a holistic view of events associated with the same computing asset and/or the same user account.

Aspects of the disclosure are initially described in the context of a computing environment. Aspects of the disclosure are further illustrated by and described with reference to an identity management diagram, a user identity management diagram, a computing asset identity management diagram, a data classification diagram, process flows apparatus diagrams, system diagrams, and flowcharts that relate to data security system asset and user identity management.

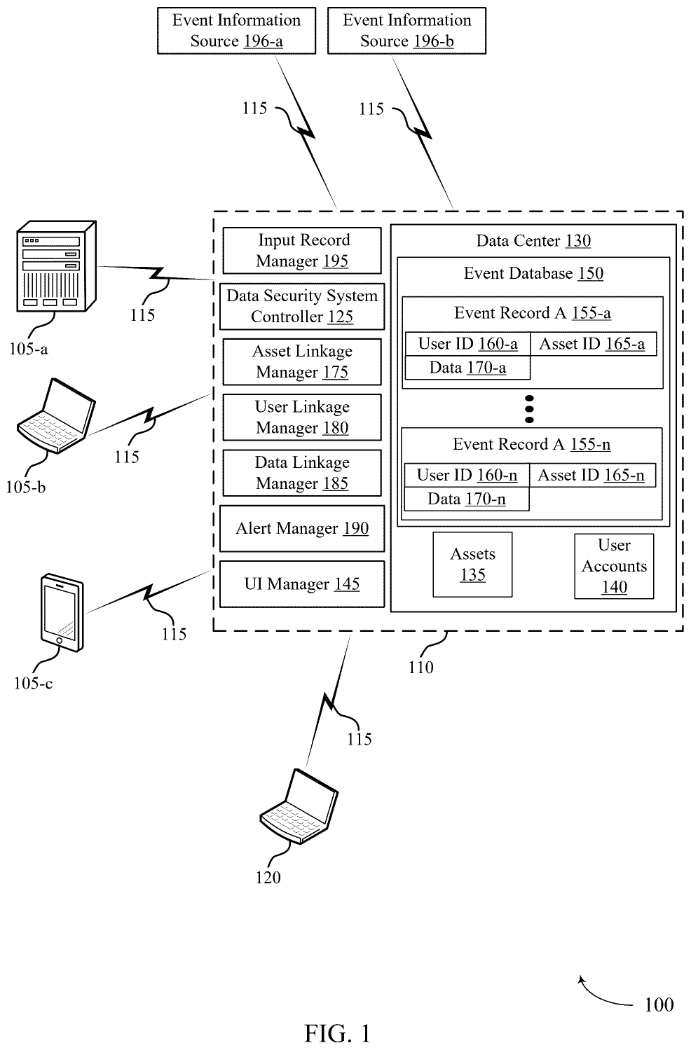

FIG. 1 illustrates an example of a computing environment 100 that supports data security system asset and user identity management in accordance with various aspects of the present disclosure.

The computing environment 100 includes one or more computing assets 105 (e.g., a computing asset 105-a, a computing asset 105-b, and a computing asset 105-c) that are monitored or protected by a data security system 110. Although shown as three computing assets 105, the data security system 110 may monitor any quantity of computing assets. The data security system 110 may communicate with the one or more computing assets 105 via communication links 115 (e.g., via a network connection). For example, the network may implement transfer control protocol and internet protocol (TCP/IP), such as the Internet, or may implement other network protocols. For example, the communication links 115 may include aspects of one or more wired networks (e.g., the Internet), one or more wireless networks (e.g., cellular networks), or any combination thereof. The communication links 115 may include aspects of one or more public networks or private networks, as well as secured or unsecured networks, or any combination thereof. The communication links 115 also may include any quantity of communications links and any quantity of hubs, bridges, routers, switches, ports or other physical or logical network components.

As described herein, a computing asset 105 may be any device, physical or virtual, capable of analyzing, storing, generating, and transmitting or receiving data. For example, a computing asset 105 may be a desktop computer, an access point, a personal digital assistant (PDA), a laptop computer, a tablet computer, a smartphone, a server, a collection of servers, a database, a data store, a virtual machine, or any combination thereof.

For example, a virtual machine may run various applications, such as a database server, an application server, or a web server. For example, a server may be used to host (e.g., create, manage) one or more virtual machines, and a computing system manager may manage a virtualized infrastructure within a computing system and perform management operations associated with the virtualized infrastructure. A computing system manager may manage the provisioning of virtual machines running within the virtualized infrastructure and provide an interface to a computing asset 105 interacting with the virtualized infrastructure. For example, the computing system manager may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of a disk of a computing system, the memory of a computing system, the processor of a computing system, the network interface of a computing system, the data storage device of a computing system, or any combination thereof in support of running the various applications. Storage resource that are virtualized may be accessed by applications as a virtual disk.

The data security system 110 may be implemented on one or more servers. The data security system 110 may include a data center 130 (e.g., one or more databases) that may include one or more servers. For example, a server may allow a client (e.g., a computing asset 105 or the data security system controller 125) to download information or files (e.g., executable, text, application, audio, image, or video files) from the server, to upload such information or files to the server, or to perform a search query related to particular information stored by the server. In general, a server may refer to one or more hardware devices that act as the host in a client-server relationship or a software process that shares a resource with or performs work for one or more clients The data center 130 may be used for data storage, management, and processing. The data center 130 may utilize multiple redundancies for security purposes. In some cases, the data stored at data center 130 may be backed up by copies of the data at a different data center (not pictured).

The data security system 110 may include a data security system controller 125, a user interface (UI) manager 145, an asset linkage manager 175, a user linkage manager 180, a data linkage manager 185, and an alert manager 190. The data security system controller 125 may manage operation of the data security system 110, including the data center 130, the UI manager 145, the asset linkage manager 175, the user linkage manager 180, the data linkage manager 185, and the alert manager 190. Though illustrated as a separate entity within the data security system 110, the data security system controller 125 may in some cases be implemented (e.g., as a software application) by one or more of servers of the data center 130. Though illustrated as a separate entities, one or more of the UI manager 145, the asset linkage manager 175, the user linkage manager 180, the data linkage manager 185, and the alert manager 190 may be implemented (e.g., as a software application) by the data security system controller 125.

In some examples, an administrative user of the data security system 110 may interact with the data security system 110 using a computing device 120. The computing device 120 may be a user device that may be used to input information to or receive information from the data security system 110. In some examples, the computing device 120 may be a computing asset 105 monitored by the data security system 110. A user of the computing device 120 may provide user inputs via the computing device 120, which may result in commands, data, or any combination thereof being communicated via the communication link 115 to the data security system 110. A user of a computing device 120 may, for example, use the computing device 120 to interact with one or more UIs (e.g., graphical user interfaces (GUIs)) to operate or otherwise interact with the data security system 110.

In some examples, the data security system 110, or aspects thereof, may be implemented within one or more cloud computing environments, which may alternatively be referred to as cloud environments. Cloud computing may refer to Internet-based computing, where shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the data security system 110, or aspects thereof, for example, through Software-as-a-Service (SaaS) or Infrastructureas-a-Service (IaaS) services provided by the cloud environment. SaaS may refer to a software distribution model in which applications are hosted by a service provider and made available to one or more client devices over a network (e.g., to one or more computing assets 105 over the communication links 115). IaaS may refer to a service in which physical computing resources are used to instantiate one or more virtual machines, the resources of which are made available to one or more client devices over a network (e.g., to one or more computing assets 105 over the communication links 115) As described herein, the data security system 110 may provide data/information security services to the computing assets 105. For example, the computing assets 105 may be associated with one or more customers of the data security system 110. For example, the data security system 110 may store (e.g., in the data center 130), a listing of known malware. The data security system 110 may scan the computing assets 105 (e.g., periodically or on-demand) for malware based on the listing of known malware. In some examples, the input record manager 195 may receive logs of scan events for malware scans. As another example, the data security system 110 may monitor for suspicious activity (e.g., unauthorized access to a computing device by a user account or downloading of suspicious software such are viruses or other malware). For example, the data center 130 may store user account information in a user account listing 140 which may indicate permissions for user accounts associated with an entity for computing assets 105 associated with the entity. In some examples, the input record manager 195 may receive log events indicating when a particular user account accesses a particular computing asset 105.

The data security system 110 may be responsible for hundreds or thousands of physical and virtual computing assets 105 across multiple networks that may collectively generate thousands or millions of input records (e.g., event logs or data records). Additionally, or alternatively, the data security system 110 may receive input records from one or more event information sources 196. For example, an event information source 196 may be a malware monitoring system locally installed on a computing asset or a third-party cloud-based malware monitoring system. As another example, an event information source 196 may be an access management system, for example implemented by a customer of the data security system 110, which may monitor which user accounts access which computing assets. Although shown as two event information sources 196 (e.g., an event information source 196-a and an event information source 196-b) the data security system 110 (e.g., the input record manager 195) may receive event information from any quantity of event information sources 196. In some examples, event information sources 196 may be internal to the data security system 110 (e.g., the data security system 110 may generate input records when performing actions such as scanning for malware or blocking the download of a virus).

The input record manager 195 may store event records 155 based on input records received from the event information sources 196 in an event record database 150. Each event record 155 may indicate a user ID 160 (e.g., associated with a user account in the user account listing 140) and a computing asset ID 165 (e.g., associated with a computing asset ID in a computing asset listing 135, where each computing asset ID is associated with a computing asset 105 monitored by the data security system 110) associated with the event record 155. Event records 155 may also include data 170 associated with the event record (e.g., one or more files). For example, the event record 155-a may include a user ID 160-a, a computing asset ID 165-a, and data 170. As another example, the event record 155-n may include a user ID 160-n, a computing asset ID 165-n, and data 170-n.

As described herein, input records from different event information sources 196 may use different computing asset IDs to refer to the same computing asset 105 or may use different user IDs to refer to the same user account. For example, a computing asset ID in an input record may be a computing asset's hostname, a computing asset's fully qualified domain name, a MAC address, an IP address, or a serial number. As another example, a user ID may be a full name, a username, a variation of a full name (e.g., last name, first name), a first initial followed by a last name, or an email address. Accordingly, the asset linkage manager 175 may identify a true computing asset ID associated with a computing asset 105 stored in a computing asset listing 135 based on the asset ID (e.g., an asset hostname, an asset fully qualified domain name, a MAC address, an IP address, or a serial number) in an input record. The input record manager 195 may store the event record 155 for the event associated with the input record using the computing asset ID 165 determined by the asset linkage manager 175. The user linkage manager 180 may identify a true user ID associated with a user account in a user account listing 140 based on the user ID (e.g., a full name, a first initial/last name, initials, email address, username, or name variation) indicated in the input record. The input record manager 195 may store the event record 155 for the event associated with the input record using the user ID 160 determined by the user linkage manager 180.

As described herein, data 170 in different event records may correspond to the same type or source of data. For example, data 170-a and data 170-n may each include sales information related to a same product that were stored on different computing assets 105. The data linkage manager 185 may identify linkages between data 170 and may indicate in the event records 155 that data 170 is linked with data 170 in another event record.

Accordingly, the data security system 110 may provide a holistic view of event records 155. For example, each event record 155 may include a user ID 160 for a user account associated with the event record, where the user account may be a user account associated with a customer or client of the data security system 110 (e.g., tracked in a user account listing 140). Accordingly, for example, the data security system 110 may track which user accounts access which data and/or which computing assets 105 monitored by the data security system 110. For example, an alert manager 190 may trigger an alert (e.g., for display on the computing device 120 via the UI manager 145) if a user account accesses a computing device that user account is unauthorized to access. As another example, each event record 155 may include a computing asset ID 165 for a computing asset 105 monitored by the data security system 110, where the computing asset 105 may be a computing asset associated with a customer of the data security system 110. (e.g., tracked in a computing asset listing 135). Accordingly, for example, the data security system 110 may track which computing assets 105 are used for different actions or are used by different users. As another example, the data security system 110 may identify if an unauthorized computing asset 105 is accessed (e.g., if a user account logs into an organization resource from an unauthorized computing asset). For example, an alert manager 190 may trigger an alert if an unauthorized computing asset appears in an event record. IT or security teams which receive the alert at the computing device 120 may accordingly notify the associated user of the breach or unauthorized access and/or correct the behavior.

For example, with the context and linkages provided by the user IDs 160, computing asset IDs 165, and linkages between data 170, IT operations, security, cloud compliance, finance, and other disciplines within an organization may view more complete information regarding which user accounts use or access which computing assets 105 and/or where (e.g., on which computing assets 105) different types of data is stored and the linkages between the data.

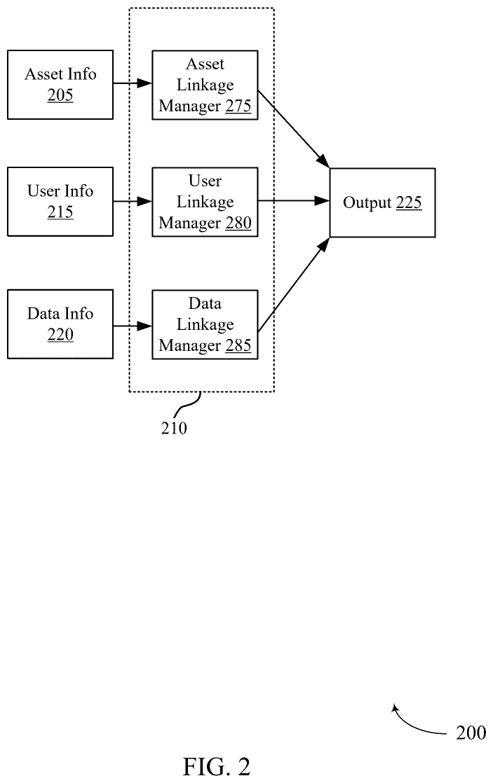

FIG. 2 shows an example of an identity management diagram 200 that supports data security system asset and user identity management in accordance with aspects of the present disclosure. The identity management diagram 200 may implement or may be implemented by aspects of the computing environment 100. For example, the identity management diagram 200 may include an asset linkage manager 275, which may be an example of an asset linkage manager 175 as described herein. As another example, the identity management diagram 200 may include a user linkage manager 280, which may be an example of a user linkage manager 180 as described herein. As another example, the identity management diagram 200 may include a data linkage manager 285, which may be an example of a data linkage manager 185 as described herein. The asset linkage manager 275, the user linkage manager 280, and the data linkage manager 285 may be implemented by a data security system 210, which may be an example of a data security system 110 as described herein.

The asset linkage manager 275 may receive asset information 205 (e.g., an asset ID such as an asset hostname, an asset fully qualified domain name, a MAC address, an IP address, or a serial number) in an input record. The asset linkage manager 275 may determine a true asset ID (e.g., associated with a computing asset 105 managed or monitored by the data security system 210).

The user linkage manager 280 may receive user information 215 (e.g., a full name, a username, a variation of a full name (e.g., last name, first name), a first initial followed by a last name, or an email address) in an input record. The user linkage manager 280 may determine a true user ID (e.g., associated with a user account in a user account listing of user accounts associated with a client or customer of the data security system 210).

The data linkage manager 285 may receive data information 220 and may link the data information 220 with other data information stored in a database accessible to the data linkage manager 285 (e.g., the data center 130 as described with reference to FIG. 1).

The output 225 from the asset linkage manager 275, the user linkage manager 280, and/or the data linkage manager 285 may accordingly include an asset ID, a user ID, and/or an indication of whether the data information 220 associated with an event record is linked with data information stored in a database accessible to the data linkage manager 285 or a data classification (e.g., confidential sales information). The output 225 may be stored in a database (e.g., as an event record 155 in an event record database 150 as described with reference to FIG. 1). The output 225 may accordingly be used to provide holistic information around computing assets 105, user accounts, and data information stored or accessed at the computing assets 105.

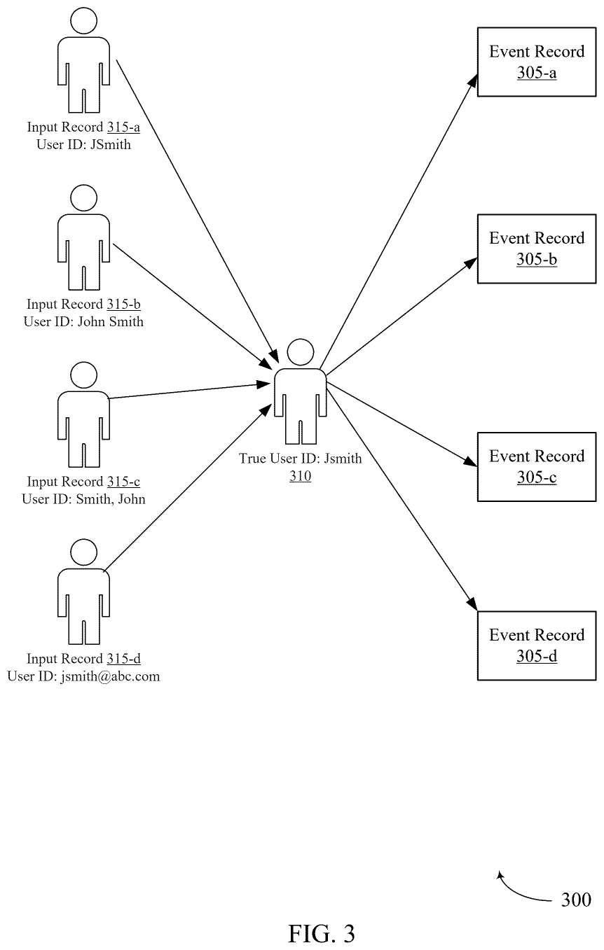

FIG. 3 shows an example of a user identity management diagram 300 that supports data security system asset and user identity management in accordance with aspects of the present disclosure. The user identity management diagram 300 may implement or may be implemented by aspects of the computing environment 100 or the identity management diagram 200.

For example, as described herein, different input records 315 obtained at a data security system 110 from different event information sources 196 may include user IDs in different formats. For example, an input record 315-a received from a first event information source may include a user ID in the first initial last name format (e.g., JSmith). An input record 315-b received from a second event information source may include a user ID in the first name last name format (e.g., John Smith). An input record 315-c received from a third event information source may include a user ID in the last name, first name format (e.g., Smith, John). An input record 315-d received from a fourth event information source may include an email address as a user ID (e.g., jsmith@abc.com). For example, the four event information sources may be four different computing assets 105. For example, the user associated with the four input records 315 may have performed actions on four different computing assets that triggered generation of the input records 315. For example, the user ID “jsmith” may access computing asset 1 from a first endpoint security system, which may generate the input record 315-a. The user ID “John Smith” may access computing asset 2 from a systems-management product, which may generate the input record 315-b. The user ID “Smith, John” may access computing asset 3 from a second endpoint security system, which may generate the input record 315-c. The user ID johnsmith@abs. com may access computing asset 4 from a system configuration manager, which may generate the input record 315-d.

Absent linkage by the data security system 110 (e.g., by the user linkage manager 180 or the user linkage manager 280), the four user IDs in the input records may appear to apply to different users. For example, basic data aggregation and deduplicating may not be able to determine a relationship between the four user IDs in the input records 315. Such standard data processing may yield four different users, each associated with one computing asset. Accordingly, if an administrator of the data security system 110 was to query how many distinct user account used the four different computing assets, the data security system 110 may return four users absent user linkage (e.g., which may be inaccurate and inflated). The data security system 110 (e.g., the user linkage manager 180 or the user linkage manager 280), however, may determine that the four user IDs in the input records 315 are associated with a same user ID (e.g., a user account associated with a customer or client of the data security system 110).

For example, the data security system 110 may use machine learning algorithms and/or intelligent data processing engines to link user IDs under a same true user ID 310. For example, as shown, the true user ID 310 may be “Jsmith.” Event records 305 for each of the input records 315 (e.g., an event record 305-a for the input record 315-a, an event record 305-b for the input record 315-b, an event record 305-c for the input record 315-c, and an event record 305-d for the input record 315-d) may be stored in a database accessible to the data security system in association with the determined true user ID 310. Determining a true user ID 310 may enable customers or clients of the data security system 110 (e.g., IT teams of customers or clients of the data security system 110) to gain insights from the user linkage. For example, customers or clients of the data security system 110 may identify that the same user, even with different user IDs, has accessed four different computing assets. As another example, if a computing asset is an unauthorized device (e.g., is a personal device of a user which may violate an organization's policies), the IT or security team may be alerted. Accordingly, IT or security teams may be able to notify users of breaches of security or protocols. Similarly, customers or clients of the data security system 110 may identify if a user account accessed a computing assed or a data record which the user account was unauthorized to access.

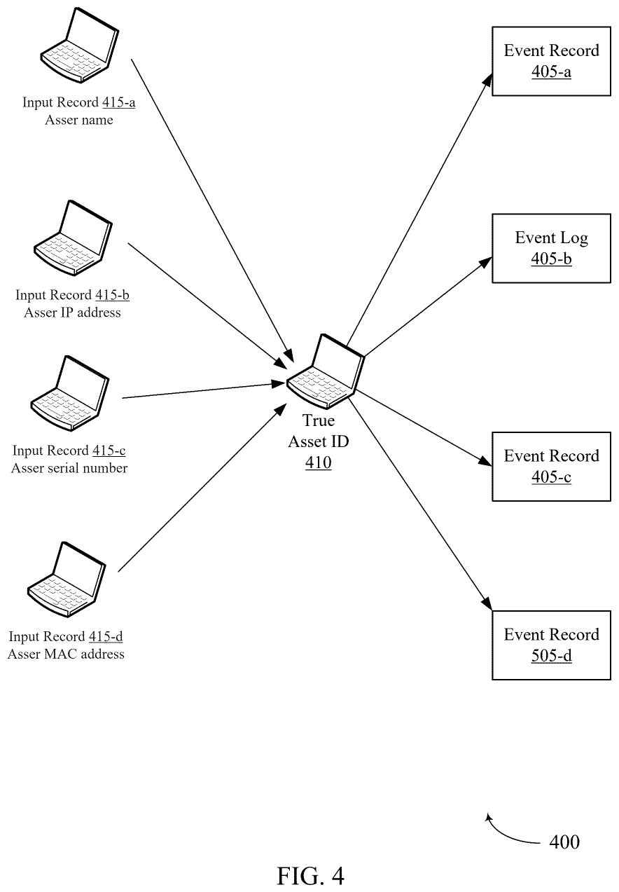

FIG. 4 shows an example of an asset identity management diagram 400 that supports data security system asset and user identity management in accordance with aspects of the present disclosure. The asset identity management diagram 400 may implement or may be implemented by aspects of the computing environment 100 or the identity management diagram 200.

For example, as described herein, different input records 415 obtained at a data security system 110 from different event information sources may include asset IDs in different formats. For example, an input record 415-a received from a first event information source may include a computing asset ID in a hostname format (e.g., “Windows-Prod01”).

For example, the first event information source may be a first endpoint security system that performed a scan of the computing asset 105. As another example, an input record 415-b received from a second event information source may include a computing asset ID in an IP address format (e.g., “10.14.75.1”). For example, the second event information source may be a cloud-based security system that performed a scan of the computing asset 105. As another example, an input record 415-c received from a third event information source may include a computing ID in serial number format (e.g., “6ZY072”). For example, the third event information source may be an endpoint management system that tracks computing assets 105 and user-logins to computing assets. As another example, an input record 415-d received from a fourth event information source may include an asset ID in a MAC address format (e.g., “12:b6:e7:5c:94:b6”). For example, the fourth event information source may be a cloud networking system.

Absent linkage by the data security system 110 (e.g., by the asset linkage manager 175 or the asset linkage manager 275), the four computing asset IDs in the input records 415 may appear to apply to different computing assets. For example, basic data aggregation and deduplicating may not be able to determine a relationship between the four computing asset IDs in the input records 415. Such standard data processing may yield four computing assets 105. Accordingly, if an administrator of the data security system 110 was to query how many computing assets were being monitored and/or managed in the input records 415, the data security system 110 may return four computing assets absent asset linkage (e.g., which may be inaccurate and inflated). The data security system 110 (e.g., the asset linkage manager 175 or the asset linkage manager 275), however, may determine that the asset IDs in the input records are associated with a same asset ID (e.g., a computing asset 105 associated with a customer or client of the data security system 110).

For example, the data security system 110 may use machine learning algorithms and/or intelligent data processing engines to link asset IDs under a same true asset ID 410. For example, as shown, the true asset ID 410 (e.g., stored in the computing asset listing 135) may be “Windows-Prod01”. Event records 405 for each of the input records 415 (e.g., an event record 405-a for the input record 415-a, an event record 405-b for the input record 415-b, an event record 405-c for the input record 415-c, and an event record 405-d for the input record 415-d) may be stored in a database (e.g., an event record database 150) accessible to the data security system 110 in association with the determined true asset ID 410. Determining a true asset ID 410 may enable customers or clients of the data security system 110 (e.g., IT or security teams of customers or clients of the data security system 110) to gain insights from the asset linkage. For example, a first event information source may provide information on the asset's malware threats, while another event information source may provide information on the asset's vulnerabilities and critical common vulnerabilities and exposures (CVEs). Once combined together, the event records for a same computing asset may be used to provide a holistic picture of the events and threats associated with the computing asset. For example, a combined view of the event records 405 associated with a same computing asset 105 may be presented via a computing device 120 as described with reference to FIG. 1.

As described herein, the data security system 110 may use machine learning algorithms and/or intelligent data processing engines to link asset IDs under a same “true” asset ID 410. For example, such machine learning algorithms and/or intelligent data processing engines may include Intelligent IP address to Host mapping (considering the time impact as the IP address can be dynamic and changes with time). As another example, such machine learning algorithms and/or intelligent data processing engines may include serial number to host mapping. As another example, such machine learning algorithms and/or intelligent data processing engines may include MAC address to host mapping. As another example, such machine learning algorithms and/or intelligent data processing engines may include serial number to host mapping asset network graph analysis, including graph node degrees calculations, edge-weighted graph pagerank algorithms, graph connected component algorithms, and/or graph clustering algorithms. The data security system 110 may similarly use such machine learning algorithms to determine linkages between user IDs as described herein.

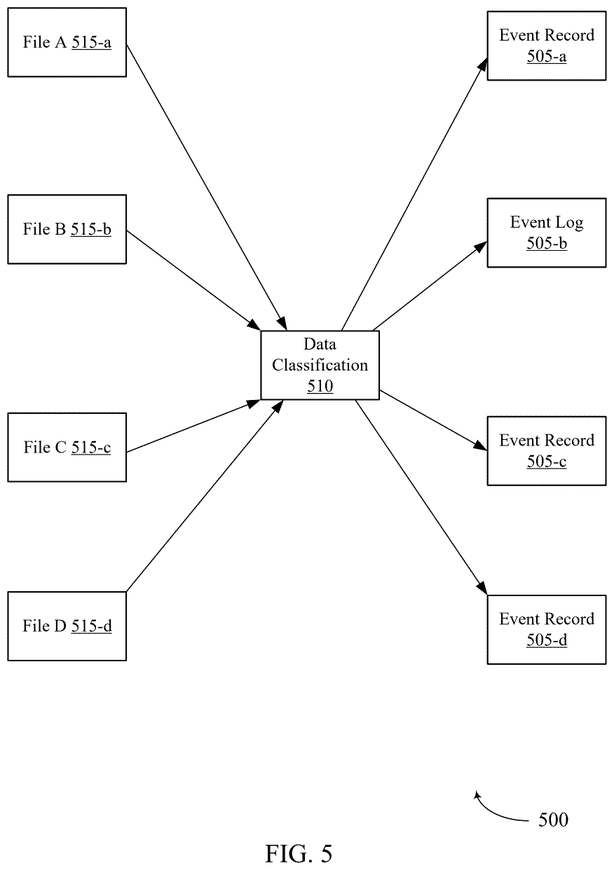

FIG. 5 shows an example of a data classification diagram 500 that supports data security system asset and user identity management in accordance with aspects of the present disclosure. The data classification diagram 500 may implement or may be implemented by aspects of the computing environment 100 or the identity management diagram 200.

Four different files (e.g., a file 515-a, a file 515-b, a file 515-c, and a file 515-d) may be stored at different systems or computing assets. For example, the file 515-a may be stored at a first cloud location (e.g., a Google Drive), the file 515-b may be stored at a second cloud location (e.g., Microsoft OneDrive), the file 515-c may be stored at a third cloud location (e.g., an Amazon Web Services location), and the file 515-d may be stored on a fourth cloud location (e.g., a Box drive). The file 515-a may be a “sales-plan.ppt” file (e.g., a presentation slide deck), the file 515-b may be a “sales-report.xlsx” file (e.g., a spreadsheet), the file 515-c may be a “sales-proposal.doc” file (e.g., a word processing document), and the file 515-d may be a “sales_marketingStrategy.pdf” file (e.g., a pdf document). Based on the titles of the files 515, the files 515 may not have an obvious relationship other than being “sales” related.

The data security system 110 (e.g., the data linkage manager 185 and/or the data linkage manager 285) may use machine learning processes such as text mining and data classification models to identify that the four files 515 have a similar confidential data classification 510 (e.g., each file 515 may include similar confidential sales data). The data security system 110 may identify user accounts and/or computing assets 105 with access to the files. For example, event records 505 may indicate when a user account downloads or accesses a file 515 via a computing asset 105. For example, an event record 505-a may indicate the user account and computing asset that accesses the file 515-a, and the event record 505-a may indicate the confidential data classification 510 for the file 515-a determined by the data security system 110. Similarly, an event record 505-b may indicate the user account and computing asset that accesses the file 515-b, and the event record 505-b may indicate the confidential data classification 510 for the file 515-b determined by the data security system 110. Similarly, an event record 505-c may indicate the user account and computing asset that accesses the file 515-c, and the event record 505-c may indicate the confidential data classification 510 for the file 515-c determined by the data security system 110. Similarly, an event record 505-d may indicate the user account and computing asset that accesses the file 515-d, and the event record 505-d may indicate the confidential data classification 510 for the file 515-d determined by the data security system 110. As another example, an event record may indicate if a user downloaded and stored a file 515, which may indicate if the user stored confidential information. Accordingly, a security team may track which user accounts are storing confidential information to track the flow of and access to confidential information, thereby reducing the risk of loss or exposure of confidential information.

The text mining and data classification models may include Latent Dirichlet Allocation (LDA), Latent Semantic Analysis (LSA), Probabilistic Latent Semantic Analysis (pSLA), Deep Learning (such as lda2vec), and/or Non-negative Matrix Factorization (NMF).

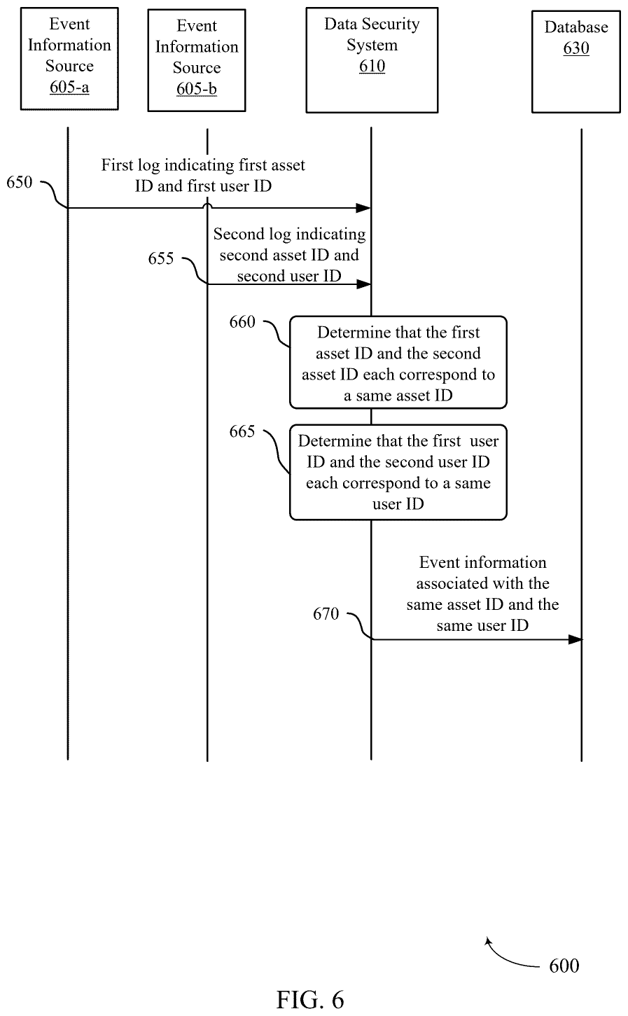

FIG. 6 shows an example of a process flow 600 that supports data security system asset and user identity management in accordance with aspects of the present disclosure. The process flow 600 may implement or may be implemented by one or more aspects of the computing environment 100, the identity management diagram 200, the user identity management diagram 300, the asset identity management diagram 400, or the data classification diagram 500. For example, the process flow 600 may include a data security system 610, which may be an example of a data security system 110 or a data security system 210 as described herein. The process flow 600 may include a database 630, which may be an example of a data center 130 or an event record database 150 as described herein. The process flow 600 may include a first event information source 605-a and a second event information source 605-b, which may be examples of event information sources 196 as described herein. In the following description of the process flow 600, operations between the data security system 610, the database 630, the first event information source 605-a, and the second event information source 605-b may be added, omitted, or performed in a different order (with respect to the exemplary order shown).

At 650, the data security system 610 may receive, from the first event information source 605-a, a first input record (e.g., a first event log or a first data record). The data security system 610 may provide data security services for a set of multiple computing assets associated with a client account of the data security system 610. The first input record may be associated with a first event, and the first input record may include a first computing asset ID and a first user ID associated with the first event.

At 655, the data security system 610 may receive, from the second event information source 605-b, a second input record (e.g., a second event log or second data record). The second input record may be associated with a second event. The second input record may include a second computing asset ID and a second user ID associated with the second event. The second computing asset ID may be different than the first computing asset ID, and the second user ID may be different than the first user ID.

At 660, the data security system 610 may determine, based on application of a first machine learning model to the first computing asset ID and the second computing asset ID, that the first computing asset ID and the second computing asset ID each correspond to a same computing asset ID for a computing asset of the set of multiple computing assets. For example, the same computing asset ID may be a true asset ID 410 as described herein. For example, the same computing asset ID may be an asset ID stored in the computing asset listing 135.

At 665, the data security system 610 may determine, based on application of a second machine learning model to the first user ID and the second user ID, that the first user ID and the second user ID each correspond to a same user ID associated with the client account. For example, the same user ID may be a true user ID 310 as described herein. For example, the same user ID may be a user account ID stored in the user account listing 140.

At 670, the data security system 610 may store, in the database 630, first information associated with the first event and second information associated with the second event in association with an ID for the computing asset based on determining that the first computing asset ID and the second computing asset ID each correspond to the computing asset and in association with the same user ID based on determining that the first user ID and the second user ID each correspond to the same user ID. For example, the data security system 610 may store a first event record 155 for the first input record and the data security system 610 may store a second event record 155 for the second input record in the database 630, and the first event record 155 and the second event record may both indicate the same computing asset ID determined at 660 and the same user ID determined at 665.

In some examples, the data security system 610 may receive a third input record from one of the first event information source 605-a, the second event information source 605-b, or a third event information source. The third input record may be associated with a third event. The third input record may include a third computing asset ID and a third user ID associated with the third event. The third computing asset ID may be different than the first computing asset ID and the second computing asset ID, and the third user ID may be different than the first user ID and the second user ID. The data security system 610 may determine, based on application of the first machine learning model to the third computing asset ID, that the third computing asset ID corresponds to the same computing asset ID. The data security system 610 may determine, based on application of the second machine learning model to the third user ID, that the third user ID corresponds to a different user ID associated with the client account than the same user ID. The data security system 610 may store, in the database 630, third information associated with the third event in association with the ID for the computing asset based on determining that the third computing asset ID corresponds to the computing asset and in association with the different user ID based on determining that the third user ID correspond to the different user ID. For example, the data security system 610 may store a third event record 155 for the third input record that may indicate the different user ID and the same computing asset ID. In some examples, the data security system 610 may determine that the third user ID is unauthorized for access on the computing asset, and the data security system 610 may generate an alert (e.g., for display on a computing device 120) based on determining that the same user ID is unauthorized for access on the computing asset.

In some examples, the data security system 610 may receive a third input record from one of the first event information source 605-a, the second event information source 605-b, or a third event information source. The third input record may be associated with a third event. The third input record may include a third computing asset ID and a third user ID associated with the third event. The third computing asset ID may be different than the first computing asset ID and the second computing asset ID, and the third user ID may be different than the first user ID and the second user ID. The data security system 610 may determine, based on application of the first machine learning model to the third computing asset ID, that the third computing asset ID corresponds to a different computing asset ID for a second computing asset of the set of multiple computing assets, the different computing asset ID different than the same computing asset ID. The data security system 610 may determine, based on application of the second machine learning model to the third user ID, that the third user ID corresponds to the same user ID. The data security system 610 may store, in the database 630, third information associated with the third event in association with a different ID for the second computing asset based on determining that the third computing asset ID corresponds to the second computing asset and in association with the same user ID based on determining that the third user ID correspond to the same user ID. For example, the data security system 610 may store a third event record 155 for the third input record that may indicate the third computing asset ID associated with the second computing asset and the same user ID.

In some examples, the data security system 610 may receive a third input record from one of the first event information source 605-a, the second event information source 605-b, or a third event information source. The third input record may be associated with a third event. The third input record may include a third computing asset ID and a third user ID associated with the third event. The third computing asset ID may be different than the first computing asset ID and the second computing asset ID, and the third user ID may be different than the first user ID and the second user ID. The data security system 610 may determine, based on application of the first machine learning model to the third computing asset ID, that the third computing asset ID corresponds to a second computing asset that is not included in the set of multiple computing assets. The data security system 610 may determine, based on application of the second machine learning model to the third user ID, that the third user ID corresponds to the same user ID. The data security system 610 may generate, an alert based on determining that the third computing asset ID corresponds to the second computing asset that is not included in the set of multiple computing assets (e.g., is not a monitored or authorized computing asset associated with the client of the data security system 610).

In some examples, the data security system 610 may determine that the same user ID is unauthorized for access on the computing asset. The data security system 610 may generate an alert based on determining that the same user ID is unauthorized for access on the computing asset.

In some examples, at least one of the first computing asset ID or the second computing asset ID may be an IP address, and the first machine learning model may be an IP address to host mapping model.

In some examples, at least one of the first computing asset ID or the second computing asset ID may be a serial number, and the first machine learning model may be a serial number to host mapping model.

In some examples, at least one of the first computing asset ID or the second computing asset ID may be a MAC address, and the first machine learning model may be a MAC address to host mapping model.

In some examples, at least one of the first machine learning model or the second machine learning model may include a graph analysis model.

In some examples, at least one of the first machine learning model or the second machine learning model may include an edge-weighted graph PageRank algorithm.

In some examples, at least one of the first machine learning model or the second machine learning model may include a graph connected-component algorithm.

In some examples, at least one of the first machine learning model or the second machine learning model may include a graph clustering algorithm.

In some examples, the data security system 610 may provide, to the first machine learning model, training data that includes a set of multiple computing asset IDs associated with the computing asset.

In some examples, the data security system 610 may provide, to the first machine learning model, training data that includes a set of multiple respective computing asset IDs associated with the set of multiple computing assets.

In some examples, the data security system 610 may provide, to the first machine learning model, training data that includes a set of multiple user IDs associated with the same user ID.

In some examples, the data security system 610 may provide, to the first machine learning model, training data that includes a set of multiple respective user IDs associated with a set of multiple user accounts associated with the client account.

In some examples, the data security system 610 may receive, with the first input record, an indication of first file ID of a first data file associated with the first event. The data security system 610 may receive, with the second input record, an indication of a second file ID of a second data file associated with the second event. The data security system 610 may determine, based at least in part on application of a third machine learning model to the first file ID and the second file ID, that the first data file and the second data file are associated with a same type of data. For example, the data security system 610 may determine that the first data file and the second data file both include confidential sales data. In some examples, the data security system may apply machine learning techniques to the contents of the first data file and the second data file to determine that the first data file and the second data file are associated with a same type of data (e.g., have a data linkage). The data security system 610 may store, in the database 630, an indication that the first event and the second event are associated with the same type of data. In some examples, the data security system 610 may determine that the first data file and the second data file are a same data file. In some examples, the third machine learning model may include a Latent Dirichlet Allocation model, a Latent Semantic Analysis model, a Probabilistic Latent Semantic Analysis model, a deep learning model, a Non-negative Matrix Factorization model, or a combination thereof. In some examples, the data security system 610 may provide, to the third machine learning model, training data that includes a set of multiple file IDs and relationship information associated with the set of multiple file IDs, and determining the first data file and the second data file are associated with the same type of data may be based on provision of the training data to the third machine learning model. In some examples, the data security system 610 may provide, to the third machine learning model, training data that includes a set of multiple files having linked data and relationship information associated with the set of multiple file, and determining the first data file and the second data file are associated with the same type of data may be based on provision of the training data to the third machine learning model.

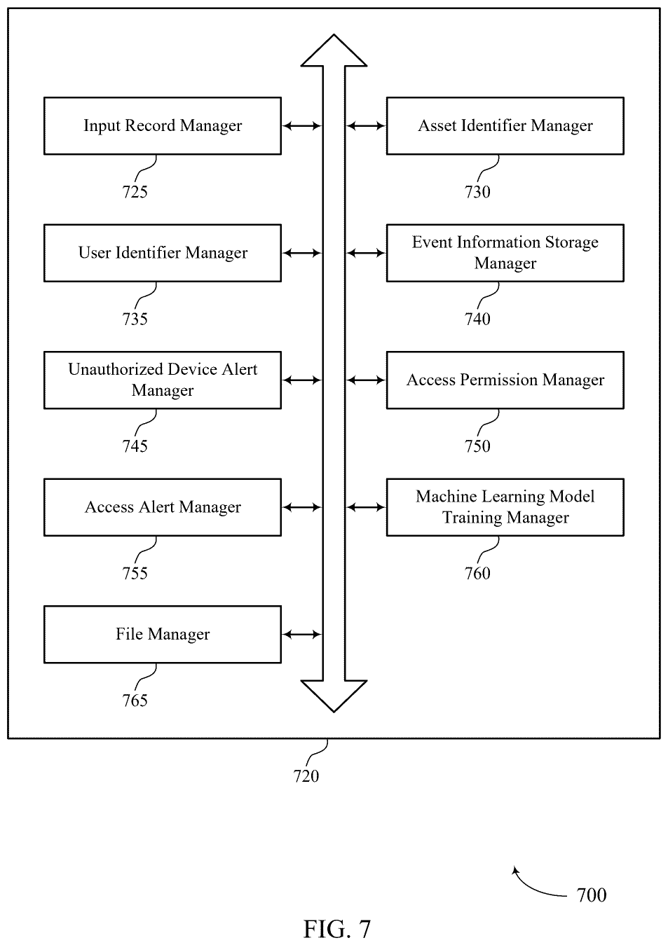

FIG. 7 shows a block diagram 700 of a Data Security System 720 that supports data security system asset and user identity management in accordance with aspects of the present disclosure. The Data Security System 720 may be an example of aspects of a Data Security System as described with reference to FIGS. 1 through 6. The Data Security System 720, or various components thereof, may be an example of means for performing various aspects of data security system asset and user identity management as described herein. For example, the Data Security System 720 may include an input record manager 725, an asset ID manager 730, a user ID manager 735, an event information storage manager 740, an unauthorized device alert manager 745, an access permission manager 750, an access alert manager 755, a machine learning model training manager 760, a file manager 765, or any combination thereof. Each of these components, or components of subcomponents thereof (e.g., one or more processors, one or more memories), may communicate, directly or indirectly, with one another (e.g., via one or more buses). In some examples, one or more components of the data security system 720 may be implemented across one or more distributed servers or as cloud applications and may communicate with each other over network connections (e.g., via communications links 115 as described herein).

The input record manager 725 may be configured to support receiving, by a data security system that provides data security services for a set of multiple computing assets associated with a client account of the data security system, a first input record from a first event information source, where the first input record is associated with a first event, and where the first input record includes a first computing asset ID and a first user ID associated with the first event. In some examples, the input record manager 725 may be configured to support receiving, by the data security system, a second input record from a second event information source different from the first event information source, where the second input record is associated with a second event, where the second input record includes a second computing asset ID and a second user ID associated with the second event, where the second computing asset ID is different than the first computing asset ID, and where the second user ID is different than the first user ID. The asset ID manager 730 may be configured to support determining, by the data security system and based on application of a first machine learning model to the first computing asset ID and the second computing asset ID, that the first computing asset ID and the second computing asset ID each correspond to a same computing asset ID for a computing asset of the set of multiple computing assets. The user ID manager 735 may be configured to support determining, by the data security system and based on application of a second machine learning model to the first user ID and the second user ID, that the first user ID and the second user ID each correspond to a same user ID associated with the client account. The event information storage manager 740 may be configured to support storing, by the data security system and in a database accessible to the data security system, first information associated with the first event and second information associated with the second event in association with an ID for the computing asset based on determining that the first computing asset ID and the second computing asset ID each correspond to the computing asset and in association with the same user ID based on determining that the first user ID and the second user ID each correspond to the same user ID.

In some examples, the input record manager 725 may be configured to support receiving, by the data security system, a third input record from one of the first event information source, the second event information source, or a third event information source, where the third input record is associated with a third event, where the third input record includes a third computing asset ID and a third user ID associated with the third event, where the third computing asset ID is different than the first computing asset ID and the second computing asset ID, and where the third user ID is different than the first user ID and the second user ID. In some examples, the asset ID manager 730 may be configured to support determining, by the data security system and based on application of the first machine learning model to the third computing asset ID, that the third computing asset ID corresponds to the same computing asset ID. In some examples, the user ID manager 735 may be configured to support determining, by the data security system and based on application of the second machine learning model to the third user ID, that the third user ID corresponds to a different user ID associated with the client account than the same user ID. In some examples, the event information storage manager 740 may be configured to support storing, by the data security system and in the database, third information associated with the third event in association with the ID for the computing asset based on determining that the third computing asset ID corresponds to the computing asset and in association with the different user ID based on determining that the third user ID correspond to the different user ID.

In some examples, the access permission manager 750 may be configured to support determining that the third user ID is unauthorized for access on the computing asset. In some examples, the access alert manager 755 may be configured to support generating an alert based on determining that the same user ID is unauthorized for access on the computing asset.

In some examples, the input record manager 725 may be configured to support receiving, by the data security system, a third input record from one of the first event information source, the second event information source, or a third event information source, where the third input record is associated with a third event, where the third input record includes a third computing asset ID and a third user ID associated with the third event, where the third computing asset ID is different than the first computing asset ID and the second computing asset ID, and where the third user ID is different than the first user ID and the second user ID. In some examples, the asset ID manager 730 may be configured to support determining, by the data security system and based on application of the first machine learning model to the third computing asset ID, that the third computing asset ID corresponds to a different computing asset ID for a second computing asset of the set of multiple computing assets, the different computing asset ID different than the same computing asset ID. In some examples, the user ID manager 735 may be configured to support determining, by the data security system and based on application of the second machine learning model to the third user ID, that the third user ID corresponds to the same user ID. In some examples, the event information storage manager 740 may be configured to support storing, by the data security system and in the database, third information associated with the third event in association with a different ID for the second computing asset based on determining that the third computing asset ID corresponds to the second computing asset and in association with the same user ID based on determining that the third user ID correspond to the same user ID.

In some examples, the input record manager 725 may be configured to support receiving, by the data security system, a third input record from one of the first event information source, the second event information source, or a third event information source, where the third input record is associated with a third event, where the third input record includes a third computing asset ID and a third user ID associated with the third event, where the third computing asset ID is different than the first computing asset ID and the second computing asset ID, and where the third user ID is different than the first user ID and the second user ID. In some examples, the asset ID manager 730 may be configured to support determining, by the data security system and based on application of the first machine learning model to the third computing asset ID, that the third computing asset ID corresponds to a second computing asset that is not included in the set of multiple computing assets. In some examples, the user ID manager 735 may be configured to support determining, by the data security system and based on application of the second machine learning model to the third user ID, that the third user ID corresponds to the same user ID. In some examples, the unauthorized device alert manager 745 may be configured to support generating, by the data security system, an alert based on determining that the third computing asset ID corresponds to the second computing asset that is not included in the set of multiple computing assets.

In some examples, the access permission manager 750 may be configured to support determining, by the data security system, that the same user ID is unauthorized for access on the computing asset. In some examples, the access alert manager 755 may be configured to support generating, by the data security system, an alert based on determining that the same user ID is unauthorized for access on the computing asset.

In some examples, at least one of the first computing asset ID or the second computing asset ID includes an IP address. In some examples, the first machine learning model includes an IP address to host mapping model.

In some examples, at least one of the first computing asset ID or the second computing asset ID includes a serial number. In some examples, the first machine learning model includes a serial number to host mapping model.

In some examples, at least one of the first computing asset ID or the second computing asset ID includes a MAC address. In some examples, the first machine learning model includes MAC address to host mapping model.

In some examples, at least one of the first machine learning model or the second machine learning model includes a graph analysis model.

In some examples, the machine learning model training manager 760 may be configured to support providing, by the data security system to the first machine learning model, training data including a set of multiple computing asset IDs associated with the computing asset.

In some examples, the machine learning model training manager 760 may be configured to support providing, by the data security system to the first machine learning model, training data including a set of multiple respective computing asset IDs associated with the set of multiple computing assets.

In some examples, the machine learning model training manager 760 may be configured to support providing, by the data security system to the first machine learning model, training data including a set of multiple user IDs associated with the same user ID.

In some examples, the machine learning model training manager 760 may be configured to support providing, by the data security system to the first machine learning model, training data including a set of multiple respective user IDs associated with a set of multiple user accounts associated with the client account.

In some examples, the input record manager 725 may be configured to support receiving, with the first input record, an indication of first file ID of a first data file associated with the first event. In some examples, the input record manager 725 may be configured to support receiving, with the second input record, an indication of a second file ID of a second data file associated with the second event. In some examples, the file manager 765 may be configured to support determining, by the data security system based on application of a third machine learning model to the first file ID and the second file ID, that the first data file and the second data file are associated with a same type of data. In some examples, the event information storage manager 740 may be configured to support storing, by the data security system and in the database, an indication that the first event and the second event are associated with the same type of data.

In some examples, determining that the first data file and the second data file are associated with the same type of data includes determining that the first data file and the second data file are a same data file.

In some examples, the third machine learning model includes a Latent Dirichlet Allocation model, a Latent Semantic Analysis model, a Probabilistic Latent Semantic Analysis model, a deep learning model, a Non-negative Matrix Factorization model, or a combination thereof.

In some examples, the machine learning model training manager 760 may be configured to support providing, by the data security system to the third machine learning model, training data including a set of multiple file IDs and relationship information associated with the set of multiple file IDs, where determining the first data file and the second data file are associated with the same type of data is based on provision of the training data to the third machine learning model.

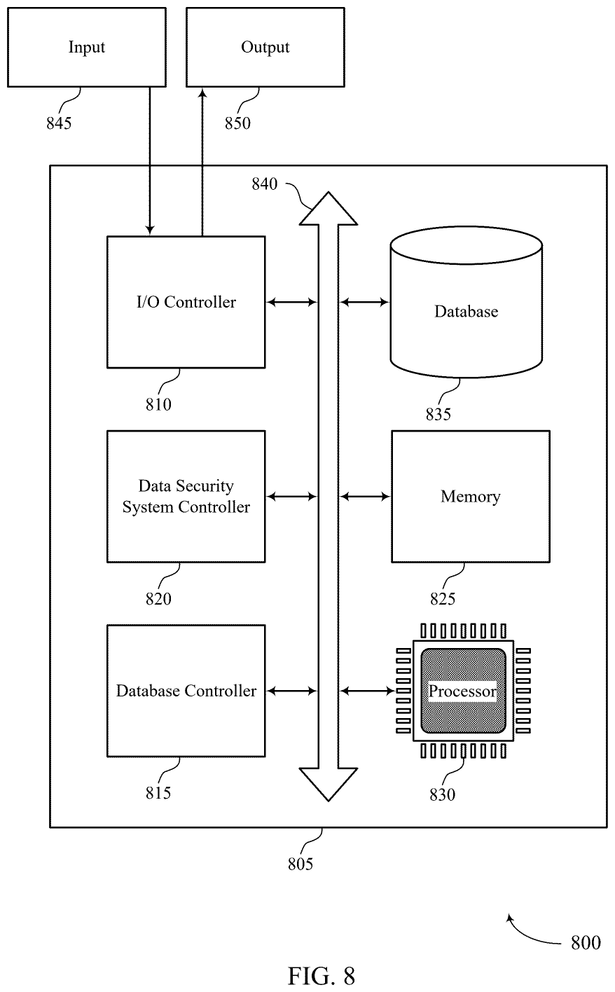

FIG. 8 shows a diagram of a system 800 including a device 805 that supports data security system asset and user identity management in accordance with aspects of the present disclosure. The device 805 may include components for bi-directional data communications including components for transmitting and receiving communications, such as a data security system controller 820, an input/output (I/O) controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting data security system asset and user identity management). The processor 830 may be an example of a single processor or multiple processors. For example, the device 805 may include one or more processors 830.

For example, the data security system controller 820 may be configured to support receiving, by a data security system that provides data security services for a set of multiple computing assets associated with a client account of the data security system, a first input record from a first event information source, where the first input record is associated with a first event, and where the first input record includes a first computing asset ID and a first user ID associated with the first event. The data security system controller 820 may be configured to support receiving, by the data security system, a second input record from a second event information source different from the first event information source, where the second input record is associated with a second event, where the second input record includes a second computing asset ID and a second user ID associated with the second event, where the second computing asset ID is different than the first computing asset ID, and where the second user ID is different than the first user ID. The data security system controller 820 may be configured to support determining, by the data security system and based on application of a first machine learning model to the first computing asset ID and the second computing asset ID, that the first computing asset ID and the second computing asset ID each correspond to a same computing asset ID for a computing asset of the set of multiple computing assets. The data security system controller 820 may be configured to support determining, by the data security system and based on application of a second machine learning model to the first user ID and the second user ID, that the first user ID and the second user ID each correspond to a same user ID associated with the client account. The data security system controller 820 may be configured to support storing, by the data security system and in a database accessible to the data security system, first information associated with the first event and second information associated with the second event in association with an ID for the computing asset based on determining that the first computing asset ID and the second computing asset ID each correspond to the computing asset and in association with the same user ID based on determining that the first user ID and the second user ID each correspond to the same user ID.

By including or configuring the data security system controller 820 in accordance with examples as described herein, the device 805 may support techniques for improved identification and management of computing assets, user accounts, and files by a data security system.

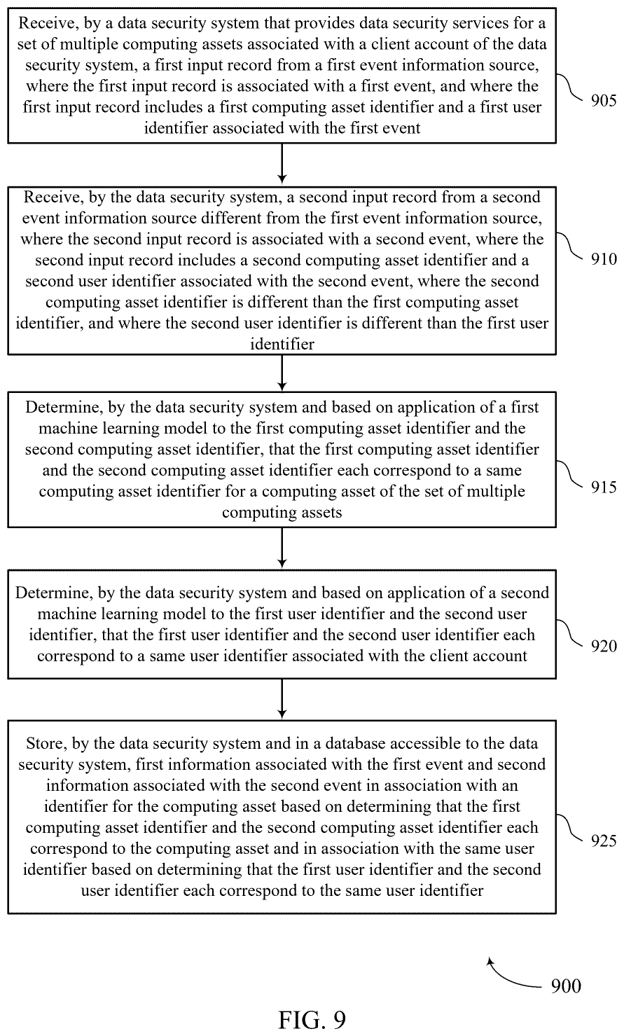

FIG. 9 shows a flowchart illustrating a method 900 that supports data security system asset and user identity management in accordance with aspects of the present disclosure. The operations of the method 900 may be implemented by a Data Security System or its components as described herein. For example, the operations of the method 900 may be performed by a Data Security System as described with reference to FIGS. 1 through 8. In some examples, a Data Security System may execute a set of instructions to control the functional elements of the Data Security System to perform the described functions. Additionally, or alternatively, the Data Security System may perform aspects of the described functions using special-purpose hardware.

At 905, the method may include receiving, by a data security system that provides data security services for a set of multiple computing assets associated with a client account of the data security system, a first input record from a first event information source, where the first input record is associated with a first event, and where the first input record includes a first computing asset ID and a first user ID associated with the first event. The operations of 905 may be performed in accordance with examples as disclosed herein. In some examples, aspects of the operations of 905 may be performed by an input record manager 725 as described with reference to FIG. 7.

At 910, the method may include receiving, by the data security system, a second input record from a second event information source different from the first event information source, where the second input record is associated with a second event, where the second input record includes a second computing asset ID and a second user ID associated with the second event, where the second computing asset ID is different than the first computing asset ID, and where the second user ID is different than the first user ID. The operations of 910 may be performed in accordance with examples as disclosed herein. In some examples, aspects of the operations of 910 may be performed by an input record manager 725 as described with reference to FIG. 7.

At 915, the method may include determining, by the data security system and based on application of a first machine learning model to the first computing asset ID and the second computing asset ID, that the first computing asset ID and the second computing asset ID each correspond to a same computing asset ID for a computing asset of the set of multiple computing assets. The operations of 915 may be performed in accordance with examples as disclosed herein. In some examples, aspects of the operations of 915 may be performed by an asset ID manager 730 as described with reference to FIG. 7.

At 920, the method may include determining, by the data security system and based on application of a second machine learning model to the first user ID and the second user ID, that the first user ID and the second user ID each correspond to a same user ID associated with the client account. The operations of 920 may be performed in accordance with examples as disclosed herein. In some examples, aspects of the operations of 920 may be performed by a user ID manager 735 as described with reference to FIG. 7.

At 925, the method may include storing, by the data security system and in a database accessible to the data security system, first information associated with the first event and second information associated with the second event in association with an ID for the computing asset based on determining that the first computing asset ID and the second computing asset ID each correspond to the computing asset and in association with the same user ID based on determining that the first user ID and the second user ID each correspond to the same user ID. The operations of 925 may be performed in accordance with examples as disclosed herein. In some examples, aspects of the operations of 925 may be performed by an event information storage manager 740 as described with reference to FIG. 7.

Aspect 1: A method, comprising: receiving, by a data security system that provides data security services for a plurality of computing assets associated with a client account of the data security system, a first input record from a first event information source, wherein the first input record is associated with a first event, and wherein the first input record includes a first computing asset ID and a first user ID associated with the first event; receiving, by the data security system, a second input record from a second event information source different from the first event information source, wherein the second input record is associated with a second event, wherein the second input record includes a second computing asset ID and a second user ID associated with the second event, wherein the second computing asset ID is different than the first computing asset ID, and wherein the second user ID is different than the first user ID; determining, by the data security system and based on application of a first machine learning model to the first computing asset ID and the second computing asset ID, that the first computing asset ID and the second computing asset ID each correspond to a same computing asset ID for a computing asset of the plurality of computing assets; determining, by the data security system and based on application of a second machine learning model to the first user ID and the second user ID, that the first user ID and the second user ID each correspond to a same user ID associated with the client account; and storing, by the data security system and in a database accessible to the data security system, first information associated with the first event and second information associated with the second event in association with an ID for the computing asset based on determining that the first computing asset ID and the second computing asset ID each correspond to the computing asset and in association with the same user ID based on determining that the first user ID and the second user ID each correspond to the same user ID.

Aspect 2: The method of aspect 1, further comprising: receiving, by the data security system, a third input record from one of the first event information source, the second event information source, or a third event information source, wherein the third input record is associated with a third event, wherein the third input record includes a third computing asset ID and a third user ID associated with the third event, wherein the third computing asset ID is different than the first computing asset ID and the second computing asset ID, and wherein the third user ID is different than the first user ID and the second user ID; determining, by the data security system and based on application of the first machine learning model to the third computing asset ID, that the third computing asset ID corresponds to the same computing asset ID; determining, by the data security system and based on application of the second machine learning model to the third user ID, that the third user ID corresponds to a different user ID associated with the client account than the same user ID; and storing, by the data security system and in the database, third information associated with the third event in association with the ID for the computing asset based on determining that the third computing asset ID corresponds to the computing asset and in association with the different user ID based on determining that the third user ID correspond to the different user ID.

Aspect 3: The method of aspect 2, further comprising: determining that the third user ID is unauthorized for access on the computing asset; and generating an alert based on determining that the same user ID is unauthorized for access on the computing asset.

Aspect 4: The method of any of aspects 1 through 3, further comprising: receiving, by the data security system, a third input record from one of the first event information source, the second event information source, or a third event information source, wherein the third input record is associated with a third event, wherein the third input record includes a third computing asset ID and a third user ID associated with the third event, wherein the third computing asset ID is different than the first computing asset ID and the second computing asset ID, and wherein the third user ID is different than the first user ID and the second user ID; determining, by the data security system and based on application of the first machine learning model to the third computing asset ID, that the third computing asset ID corresponds to a different computing asset ID for a second computing asset of the plurality of computing assets, the different computing asset ID different than the same computing asset ID; determining, by the data security system and based on application of the second machine learning model to the third user ID, that the third user ID corresponds to the same user ID; and storing, by the data security system and in the database, third information associated with the third event in association with a different ID for the second computing asset based on determining that the third computing asset ID corresponds to the second computing asset and in association with the same user ID based on determining that the third user ID correspond to the same user ID.

Aspect 5: The method of any of aspects 1 through 4, further comprising: receiving, by the data security system, a third input record from one of the first event information source, the second event information source, or a third event information source, wherein the third input record is associated with a third event, wherein the third input record includes a third computing asset ID and a third user ID associated with the third event, wherein the third computing asset ID is different than the first computing asset ID and the second computing asset ID, and wherein the third user ID is different than the first user ID and the second user ID; determining, by the data security system and based on application of the first machine learning model to the third computing asset ID, that the third computing asset ID corresponds to a second computing asset that is not included in the plurality of computing assets; determining, by the data security system and based on application of the second machine learning model to the third user ID, that the third user ID corresponds to the same user ID; and generating, by the data security system, an alert based on determining that the third computing asset ID corresponds to the second computing asset that is not included in the plurality of computing assets.

Aspect 6: The method of any of aspects 1 through 5, further comprising: determining, by the data security system, that the same user ID is unauthorized for access on the computing asset; and generating, by the data security system, an alert based on determining that the same user ID is unauthorized for access on the computing asset.

Aspect 7: The method of any of aspects 1 through 6, wherein at least one of the first computing asset ID or the second computing asset ID comprises an IP address, and the first machine learning model comprises an IP address to host mapping model.

Aspect 8: The method of any of aspects 1 through 7, wherein at least one of the first computing asset ID or the second computing asset ID comprises a serial number, and the first machine learning model comprises a serial number to host mapping model.

Aspect 9: The method of any of aspects 1 through 8, wherein at least one of the first computing asset ID or the second computing asset ID comprises a MAC address, and the first machine learning model comprises MAC address to host mapping model.

Aspect 10: The method of any of aspects 1 through 9, wherein at least one of the first machine learning model or the second machine learning model comprises a graph analysis model.

Aspect 11: The method of any of aspects 1 through 10, further comprising: providing, by the data security system to the first machine learning model, training data comprising a plurality of computing asset IDs associated with the computing asset.

Aspect 12: The method of any of aspects 1 through 11, further comprising: providing, by the data security system to the first machine learning model, training data comprising a plurality of respective computing asset IDs associated with the plurality of computing assets.

Aspect 13: The method of any of aspects 1 through 12, further comprising: providing, by the data security system to the first machine learning model, training data comprising a plurality of user IDs associated with the same user ID.

Aspect 14: The method of any of aspects 1 through 13, further comprising: providing, by the data security system to the first machine learning model, training data comprising a plurality of respective user IDs associated with a plurality of user accounts associated with the client account.

Aspect 15: The method of any of aspects 1 through 14, further comprising: receiving, with the first input record, an indication of first file ID of a first data file associated with the first event; receiving, with the second input record, an indication of a second file ID of a second data file associated with the second event; determining, by the data security system based at least in part on application of a third machine learning model to the first file ID and the second file ID, that the first data file and the second data file are associated with a same type of data; and storing, by the data security system and in the database, an indication that the first event and the second event are associated with the same type of data.

Aspect 16: The method of aspect 15, wherein determining that the first data file and the second data file are associated with the same type of data comprises determining that the first data file and the second data file are a same data file.

Aspect 17: The method of any of aspects 15 through 16, wherein the third machine learning model comprises a Latent Dirichlet Allocation model, a Latent Semantic Analysis model, a Probabilistic Latent Semantic Analysis model, a deep learning model, a Non-negative Matrix Factorization model, or a combination thereof.

Aspect 18: The method of any of aspects 15 through 17, further comprising: providing, by the data security system to the third machine learning model, training data comprising a plurality of file IDs and relationship information associated with the plurality of file IDs, wherein determining the first data file and the second data file are associated with the same type of data is based on provision of the training data to the third machine learning model.

Aspect 19: An apparatus comprising one or more memories storing processor-executable code, and one or more processors coupled with the one or more memories and individually or collectively operable to execute the code to cause the apparatus to perform a method of any of aspects 1 through 18.

Aspect 20: An apparatus comprising at least one means for performing a method of any of aspects 1 through 18.

Aspect 21: A non-transitory computer-readable medium storing code the code comprising instructions executable by one or more processors to perform a method of any of aspects 1 through 18.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples. ” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
receiving, by a data security system that provides data security services for a plurality of computing assets associated with a client account of the data security system, a first input record from a first event information source, wherein the first input record is associated with a first event, and wherein the first input record includes a first computing asset identifier and a first user identifier associated with the first event;
receiving, by the data security system, a second input record from a second event information source different from the first event information source, wherein the second input record is associated with a second event, wherein the second input record includes a second computing asset identifier and a second user identifier associated with the second event, wherein the second computing asset identifier is different than the first computing asset identifier, and wherein the second user identifier is different than the first user identifier;
determining, by the data security system and based on application of a first machine learning model to the first computing asset identifier and the second computing asset identifier, that the first computing asset identifier and the second computing asset identifier each correspond to a same computing asset identifier for a computing asset of the plurality of computing assets;
determining, by the data security system and based on application of a second machine learning model to the first user identifier and the second user identifier, that the first user identifier and the second user identifier each correspond to a same user identifier associated with the client account; and
storing, by the data security system and in a database accessible to the data security system, first information associated with the first event and second information associated with the second event in association with an identifier for the computing asset based on determining that the first computing asset identifier and the second computing asset identifier each correspond to the computing asset and in association with the same user identifier based on determining that the first user identifier and the second user identifier each correspond to the same user identifier.

2. The method of claim 1, further comprising:
receiving, by the data security system, a third input record from one of the first event information source, the second event information source, or a third event information source, wherein the third input record is associated with a third event, wherein the third input record includes a third computing asset identifier and a third user identifier associated with the third event, wherein the third computing asset identifier is different than the first computing asset identifier and the second computing asset identifier, and wherein the third user identifier is different than the first user identifier and the second user identifier;
determining, by the data security system and based on application of the first machine learning model to the third computing asset identifier, that the third computing asset identifier corresponds to the same computing asset identifier;
determining, by the data security system and based on application of the second machine learning model to the third user identifier, that the third user identifier corresponds to a different user identifier associated with the client account than the same user identifier; and
storing, by the data security system and in the database, third information associated with the third event in association with the identifier for the computing asset based on determining that the third computing asset identifier corresponds to the computing asset and in association with the different user identifier based on determining that the third user identifier correspond to the different user identifier.

3. The method of claim 2, further comprising:
determining that the third user identifier is unauthorized for access on the computing asset; and
generating an alert based on determining that the same user identifier is unauthorized for access on the computing asset.

4. The method of claim 1, further comprising:
receiving, by the data security system, a third input record from one of the first event information source, the second event information source, or a third event information source, wherein the third input record is associated with a third event, wherein the third input record includes a third computing asset identifier and a third user identifier associated with the third event, wherein the third computing asset identifier is different than the first computing asset identifier and the second computing asset identifier, and wherein the third user identifier is different than the first user identifier and the second user identifier;
determining, by the data security system and based on application of the first machine learning model to the third computing asset identifier, that the third computing asset identifier corresponds to a different computing asset identifier for a second computing asset of the plurality of computing assets, the different computing asset identifier different than the same computing asset identifier;
determining, by the data security system and based on application of the second machine learning model to the third user identifier, that the third user identifier corresponds to the same user identifier; and
storing, by the data security system and in the database, third information associated with the third event in association with a different identifier for the second computing asset based on determining that the third computing asset identifier corresponds to the second computing asset and in association with the same user identifier based on determining that the third user identifier correspond to the same user identifier.

5. The method of claim 1, further comprising:
receiving, by the data security system, a third input record from one of the first event information source, the second event information source, or a third event information source, wherein the third input record is associated with a third event, wherein the third input record includes a third computing asset identifier and a third user identifier associated with the third event, wherein the third computing asset identifier is different than the first computing asset identifier and the second computing asset identifier, and wherein the third user identifier is different than the first user identifier and the second user identifier;
determining, by the data security system and based on application of the first machine learning model to the third computing asset identifier, that the third computing asset identifier corresponds to a second computing asset that is not included in the plurality of computing assets;
determining, by the data security system and based on application of the second machine learning model to the third user identifier, that the third user identifier corresponds to the same user identifier; and
generating, by the data security system, an alert based on determining that the third computing asset identifier corresponds to the second computing asset that is not included in the plurality of computing assets.

6. The method of claim 1, further comprising:
determining, by the data security system, that the same user identifier is unauthorized for access on the computing asset; and
generating, by the data security system, an alert based on determining that the same user identifier is unauthorized for access on the computing asset.

7. The method of claim 1, wherein:
at least one of the first computing asset identifier or the second computing asset identifier comprises an internet protocol address, and
the first machine learning model comprises an internet protocol address to host mapping model.

8. The method of claim 1, wherein:
at least one of the first computing asset identifier or the second computing asset identifier comprises a serial number, and
the first machine learning model comprises a serial number to host mapping model.

9. The method of claim 1, wherein:
at least one of the first computing asset identifier or the second computing asset identifier comprises a medium access control address, and
the first machine learning model comprises medium access control address to host mapping model.

10. The method of claim 1, wherein at least one of the first machine learning model or the second machine learning model comprises a graph analysis model.

11. The method of claim 1, further comprising:
providing, by the data security system to the first machine learning model, training data comprising a plurality of computing asset identifiers associated with the computing asset.

12. The method of claim 1, further comprising:
providing, by the data security system to the first machine learning model, training data comprising a plurality of respective computing asset identifiers associated with the plurality of computing assets.

13. The method of claim 1, further comprising:
providing, by the data security system to the first machine learning model, training data comprising a plurality of user identifiers associated with the same user identifier.

14. The method of claim 1, further comprising:
providing, by the data security system to the first machine learning model, training data comprising a plurality of respective user identifiers associated with a plurality of user accounts associated with the client account.

15. The method of claim 1, further comprising:
receiving, with the first input record, an indication of first file identifier of a first data file associated with the first event;
receiving, with the second input record, an indication of a second file identifier of a second data file associated with the second event;
determining, by the data security system based at least in part on application of a third machine learning model to the first file identifier and the second file identifier, that the first data file and the second data file are associated with a same type of data; and
storing, by the data security system and in the database, an indication that the first event and the second event are associated with the same type of data.

16. The method of claim 15, wherein determining that the first data file and the second data file are associated with the same type of data comprises determining that the first data file and the second data file are a same data file.

17. The method of claim 15, wherein the third machine learning model comprises a Latent Dirichlet Allocation model, a Latent Semantic Analysis model, a Probabilistic Latent Semantic Analysis model, a deep learning model, a Non-negative Matrix Factorization model, or a combination thereof.

18. The method of claim 15, further comprising:
providing, by the data security system to the third machine learning model, training data comprising a plurality of file identifiers and relationship information associated with the plurality of file identifiers, wherein determining the first data file and the second data file are associated with the same type of data is based on provision of the training data to the third machine learning model.

19. An apparatus, comprising:
one or more memories storing processor-executable code; and
one or more processors coupled with the one or more memories and individually or collectively operable to execute the code to cause the apparatus to:
receive, by a data security system that provides data security services for a plurality of computing assets associated with a client account of the data security system, a first input record from a first event information source, wherein the first input record is associated with a first event, and wherein the first input record includes a first computing asset identifier and a first user identifier associated with the first event;
receive, by the data security system, a second input record from a second event information source different from the first event information source, wherein the second input record is associated with a second event, wherein the second input record includes a second computing asset identifier and a second user identifier associated with the second event, wherein the second computing asset identifier is different than the first computing asset identifier, and wherein the second user identifier is different than the first user identifier;
determine, by the data security system and based on application of a first machine learning model to the first computing asset identifier and the second computing asset identifier, that the first computing asset identifier and the second computing asset identifier each correspond to a same computing asset identifier for a computing asset of the plurality of computing assets;
determine, by the data security system and based on application of a second machine learning model to the first user identifier and the second user identifier, that the first user identifier and the second user identifier each correspond to a same user identifier associated with the client account; and
store, by the data security system and in a database accessible to the data security system, first information associated with the first event and second information associated with the second event in association with an identifier for the computing asset based on determining that the first computing asset identifier and the second computing asset identifier each correspond to the computing asset and in association with the same user identifier based on determining that the first user identifier and the second user identifier each correspond to the same user identifier.

20. A non-transitory computer-readable medium storing code, the code comprising instructions executable by one or more processors to:
receive, by a data security system that provides data security services for a plurality of computing assets associated with a client account of the data security system, a first input record from a first event information source, wherein the first input record is associated with a first event, and wherein the first input record includes a first computing asset identifier and a first user identifier associated with the first event;
receive, by the data security system, a second input record from a second event information source different from the first event information source, wherein the second input record is associated with a second event, wherein the second input record includes a second computing asset identifier and a second user identifier associated with the second event, wherein the second computing asset identifier is different than the first computing asset identifier, and wherein the second user identifier is different than the first user identifier;
determine, by the data security system and based on application of a first machine learning model to the first computing asset identifier and the second computing asset identifier, that the first computing asset identifier and the second computing asset identifier each correspond to a same computing asset identifier for a computing asset of the plurality of computing assets;
determine, by the data security system and based on application of a second machine learning model to the first user identifier and the second user identifier, that the first user identifier and the second user identifier each correspond to a same user identifier associated with the client account; and
store, by the data security system and in a database accessible to the data security system, first information associated with the first event and second information associated with the second event in association with an identifier for the computing asset based on determining that the first computing asset identifier and the second computing asset identifier each correspond to the computing asset and in association with the same user identifier based on determining that the first user identifier and the second user identifier each correspond to the same user identifier.
